(19) United States
(12) Patent Application Publication
(10) Pub. No.: US 2016/0321716 A1
(43) Pub. Date: Nov. 3, 2016

(54) SYSTEM, METHOD, AND NON-TRANSITORY COMPUTER-READABLE STORAGE MEDIA FOR ENHANCING ONLINE PRODUCT SEARCH THROUGH MULTIOBJECTIVE OPTIMIZATION OF PRODUCT SEARCH RANKING FUNCTIONS

(71) Applicant: Wal-Mart Stores, Inc., Bentonville, AR (US)

(72) Inventors: Dintyala Venkata Subrahmanya Ravikant, Fremont, CA (US); Huizhong Duan, Redwood City, CA (US); Parikshit Sondhi, Mountain View, CA (US)

(21) Appl. No.: 14/701,363

(22) Filed: Apr. 30, 2015

(51) Int. Cl. G06Q 30/06

(52) U.S. Cl. CPC G06Q 30/0601

(57) ABSTRACT

A system, method, and non-transitory computer-readable storage media includes a computer system having a server configured to generate labeled data on products to produce pairwise preferences, to combine the pairwise preferences, editorial ratings of the products, and inferred consumer relevances of the products to produce an ideal ranking for the products, to learn rerank function parameters based on the ideal ranking for the products, to output product rerank function parameters based on the learned rerank function parameters, to receive a product search query from a user device of a user, to get products that match the product search query, to rank the products based on the product rerank function parameters, and to output the ranked products as search results to the user device of the user.

### BACKGROUND OF THE INVENTION

1. Field of the Invention

The present invention relates generally to enhancing product searches on websites, and more particularly, to systems, methods, and computer-readable storage medias that enhance online product searches through optimization of product search ranking functions.

2. Description of the Related Art

Many consumers desire to order items or products remotely, e.g., on-line, through the Internet, using a specially designed application or app on a personal computer or mobile device, such as a tablet or cell phone. The consumer enters the name of the product in a search query on the app and a search engine of the retailer presents search results of selected products to the personal computer or mobile device of the consumer.

In addition, known search engines may sort the selected products based on relevance. Known search engines are also known for doing well for search queries and products where they have sufficient user interaction/click logs, however, they face difficulties for products for which clicks are due to users checking out the products but do not translate into purchases. Search engine's notion of relevance may diverge significantly from consumer notion of relevance and the sorted lists do not display products that are relevant to the consumers needs.

Search ranking functions were designed and optimized manually based on limited data points with relevance of an engineer's intuition for search quality, namely, retrieval quality, consumer preference, and conversion potential. Methods in practical use at popular search engines rely heavily on large collections of up-to-date editorial ratings by humans on (search query, retrieved document) pairs of products. Consumer preference inferences in web searches rely on clicks (in other words, the methods end at clicks) even though online retailers can see purchases, returns, reviews.

However, product searches on websites suffer from the disadvantage that some products may not be presented in the search results to the consumer. This may be due to the manual tuning because it is extremely difficult, if not nearly impossible, to manually tune ranking/scoring functions combining hundreds of product features. Another disadvantage with manual tuning is that over-fitting is a common issue from human limitations on small validation sets used in tuning. Yet another disadvantage of manual tuning is time sensitivity (e.g., user expectations change for “ipad air” before and after release of air 2) and catalog sensitivity. So one ends up with long lead times because each tuning takes multiple months.

Further, product searches on websites suffer from the disadvantage that some products may not be presented in the search results to the consumer based on editorial ratings. One disadvantage with editorial ratings is that there is limited correlation with revenue/conversion maximization once the “editorial quality” is good. In other words, high editorial quality is necessary but not sufficient for product view rate (PVR) maximization or conversion maximization. Another disadvantage with editorial ratings is the time sensitivity of editorial ratings. Yet another disadvantage with editorial ratings is that it is expensive to obtain ratings from humans.

In addition, proposals for ranking from the research community lead to many disadvantages like some products may not be presented in the search results to the consumer at all. Another disadvantage with product rank proposals is the focus on a single objective such as editorial relevance. Yet another disadvantage with product rank proposals is that the methods for label data generation end at clicks.

It is, therefore, desirable to provide a new system and method that optimizes editorial quality of retrieved products, consumer preferences, and conversion simultaneously for an online product search in an e-commerce marketplace for a large retailer. It is also desirable to provide a new system and method that integrates inferred product rankings with editorial ratings for automated tuning of ranking functions to improve product ranking. It is further desirable to provide a new system and method that uses product search user behavior models and incorporates these models into methods for labeled data generation at scale in an automated fashion to improve product ranking. Thus, there is a need in the art to provide a system that enhances online product searches through multi-objective optimization of product search ranking functions and method of using same that meets at least one of these desires.

### SUMMARY OF THE INVENTION

In different embodiments of the present invention, systems, methods, and computer-readable storage medias enhance online product searches through multi-objective optimization of product search ranking functions accessed by a consumer via a website/app.

In one embodiment, a system includes a computer system having a server configured to generate labeled data on products to produce pairwise preferences, to combine the pairwise preferences, editorial ratings of the products, and inferred consumer relevances of the products to produce an ideal ranking for the products, to learn rerank function parameters based on the ideal ranking for the products, to output product rerank function parameters from the learning. The server is also configured to receive a product search query from a user device of a user, to get products that match the product search query, to rank the products based on the product rerank function parameters, and to output the ranked products as search results to the user device of the user.

In another embodiment, a method includes the steps of generating, with a computer system, labeled data on products to produce pairwise preferences, combining, with the computer system, the pairwise preferences, editorial ratings of the products, and inferred consumer relevances of the products to produce an ideal ranking for the products, learning, with the computer system, rerank function parameters based on the ideal ranking for the products, and outputting, with the computer system, product rerank function parameters from the learning. The method further includes the steps of receiving, with the computer system, a product search query from a user device of a user, getting, with the computer system, products that match the product search query, ranking, with the computer system, the products based on the product rerank function parameters, and outputting, with the computer system, the ranked products as search results to the user device of the user.

In yet another embodiment, one or more non-transitory computer-readable storage media, having computer-executable instructions embodied thereon are provided. When executed by at least one processor, the computer-executable instructions cause the processor to generate labeled data on products to produce pairwise preferences, combine the pairwise preferences, editorial ratings of the products, and inferred consumer relevances of the products to produce an ideal ranking for the products, learn rerank function parameters based on the ideal ranking for the products, output product rerank function parameters from the learning, receive a product search query from a user device of a user, get products that match the product search query, rank the products based on the product rerank function parameters, and output the ranked products as search results to the user device of the user.

One advantage of the present invention is that a system, method, and non-transitory computer-readable storage media is provided that incorporates product search user behavior models that account for user actions along a complete purchase cycle including post purchase actions such as product returns, reviews, ratings, and recommendations. Another advantage of the present invention is that the system, method, and non-transitory computer-readable storage media provides a framework to mine labeled data at scale and refine/tune product ranking models for a combination of fitness metrics such as textual relevance, revenue maximization, click through rate maximization, consistency with pairwise preferences to improve product ranking. Yet another advantage of the present invention is that the system, method, and non-transitory computer-readable storage media incorporates labeled data generation that infers consumer preferences/relevance of products given behavior models through different approaches—query specific position bias estimation, pairwise preferences—to improve product ranking. Still another advantage of the present invention is that the system, method, and non-transitory computer-readable storage media incorporate multi-objective optimization, which is an evaluation of trade-offs between search quality in terms of editorial ratings and consumer preferences and multi-criteria decision making to improve product ranking.

Other features and advantages of the present invention will be readily appreciated, as the same becomes better understood, after reading the subsequent description taken in conjunction with the accompanying drawings.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagrammatic view of a system, according to one embodiment of the present invention, illustrated in operational relationship with at least one user device of a consumer.

FIG. 2 is a diagrammatic view of a portion of the system of FIG. 1.

FIG. 3 is a diagrammatic view of one portion of the system and user device of FIG. 1.

FIG. 4 is a diagrammatic view of another portion of the system and user device of FIG. 3.

FIG. 5 is a flowchart of a method that may be used with the system shown in FIGS. 1 through 4, according to an embodiment of the present invention.

FIG. 6 is an illustration of an exemplary screenshot from the system of FIGS. 1 through 4, according to an embodiment of the present invention.

FIG. 7 is an illustration of an exemplary screenshot from the system of FIGS. 1 through 4, according to an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF THE PREFERRED EMBODIMENT(S)

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should be appreciated that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

The disclosure particularly describes how product search at an online retailer is enhanced through multi-objective optimization of product search ranking functions for products to be presented to a consumer for a predefined user activity such as, for example, finding and researching a product and/or finding and purchasing a product via a website/app. Particularly, the present disclosure describes how a system provides a website/app to a consumer to allow the consumer to conduct an online product search to purchase and/or order products via the website/app, and to present reranked products within the website/app to the consumer that facilitate inducing the consumer to purchase a product via the website/app. In addition, the disclosure describes how to mine product pairwise preferences based on full funnel attribution of user actions (clicks, add to carts, purchases) on ranked products to reduce position bias in deriving labeled product data with an existing system.

Click logs including user purchase actions provide rich data sources that can inform search. As such, the disclosure provides a framework for learning to rank products that enables multi-objective minimization for learning and scalable workflows to refine/tune relevance models for ranking products. The disclosure describes combining labeled product data from multiple sources such as human (editorial) and machine generated (purchases/relative preferences from click logs). By integrating actions along the purchase flow and post purchase actions in deriving labeled product data and displaying product lists based on the reranked products, the system transforms the search data into relevant product information and generates and displays product listings that are more relevant to the needs of the consumer over known search engines and that increase the likelihood of a consumer purchasing a product displayed in the list, thus increasing the overall revenue being generated by the website/app.

With reference to the FIGS. and in operation, the present invention provides a system 10, method and computer product media that facilitates an enhanced online product search through optimization of product search ranking functions when scoring products on a website/app.

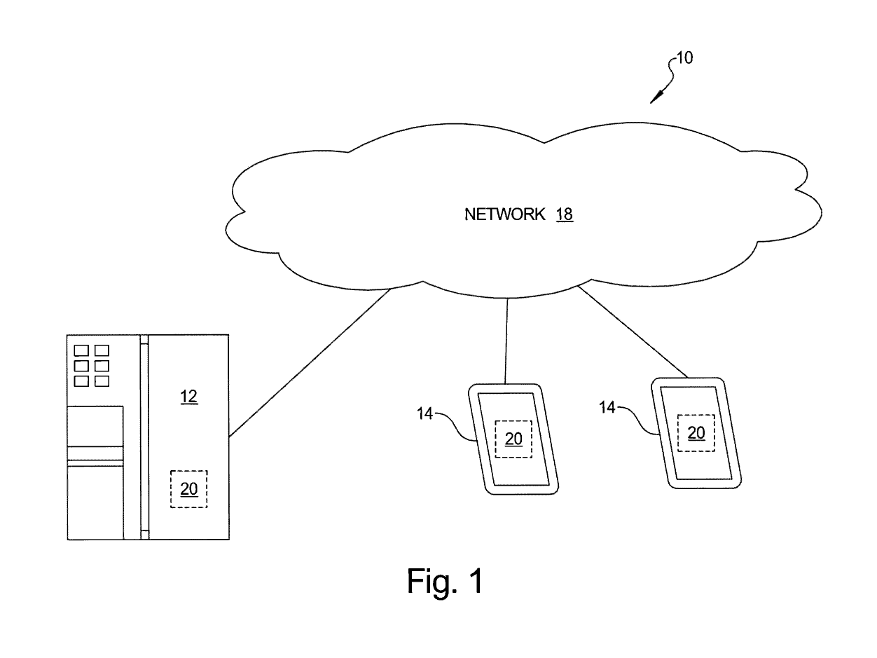

Referring to FIG. 1, an exemplary environment in which the system 10, according to the present invention, operates is illustrated. The system 10 in which methods described hereinbelow may be implemented. The system 10 may include a server system 12 that may be embodied as one or more server computers each including one or more processors that are in data communication with one another. The server system 12 may be in data communication with one or more user devices 14. In the methods disclosed herein, the user devices 14 are advantageously mobile devices such as a mobile phone or tablet computer. In some embodiments, some or all of the methods disclosed herein may be performed using a user device 14 such as a desktop computer or any other computing device as the user device 14. For purposes of this disclosure, discussion of communication with a user or entity or activity performed by the user or entity may be interpreted as communication with a user device 14 associated with the user or entity or activity taking place on a computer associated with the user or entity. In some embodiments, separate computers of the server system 12 may handle communication with the user devices 14.

Some or all of the server 12 and user devices 14 may communicate with one another by means of a network 18. The network 18 may be embodied as a peer-to-peer wireless connection between devices, a connection through a local area network (LAN), WiFi network, the Internet, or any other communication medium or system.

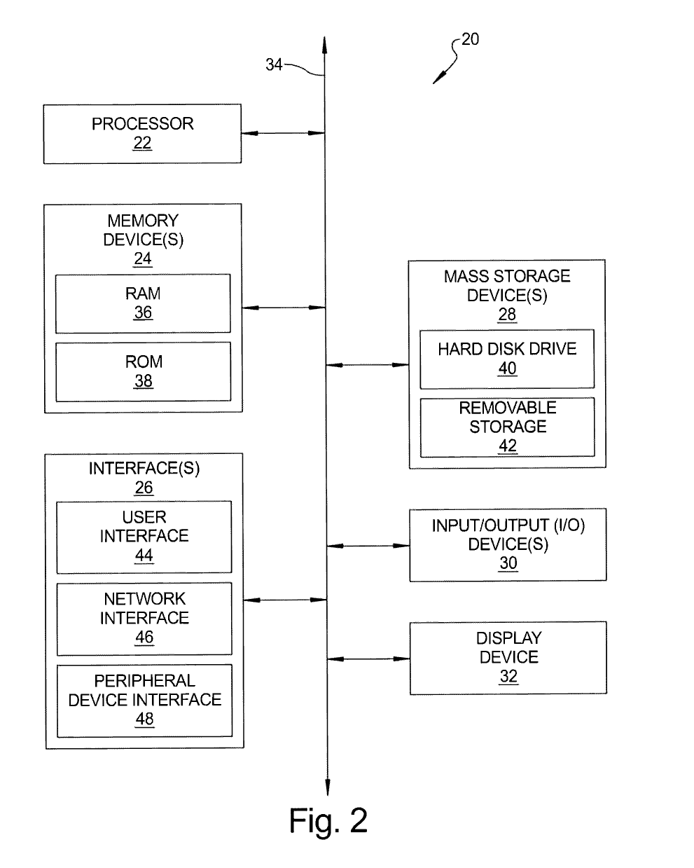

Referring to FIG. 2, an example computing device 20 for the system 10 and user device 14 is shown. The computing device 20 may be used to perform various procedures, such as those discussed herein. The computing device 20 can function as a server, a user, or any other computing entity. The computing device 20 can perform various monitoring functions as discussed herein, and can execute one or more application programs, such as the application programs described herein. The computing device 20 can be any of a wide variety of computing devices, such as a desktop computer, a notebook computer, a server computer, a handheld computer, tablet computer and the like.

The computing device 20 includes one or more processor(s) 22, one or more memory device(s) 24, one or more interface(s) 26, one or more mass storage device(s) 28, one or more Input/Output (I/O) device(s) 30, and one or more display device(s) 32, all of which are coupled to one or more bus(es) 34. The processor(s) 22 include one or more processors or controllers that execute instructions stored in memory device(s) 24 and/or mass storage device(s) 28. The processor(s) 22 may also include various types of computer-readable media, such as cache memory.

The memory device(s) 24 include various computer-readable media, such as volatile memory (e.g., random access memory (RAM) 36) and/or nonvolatile memory (e.g., read-only memory (ROM) 38). The memory device(s) 24 may also include rewritable ROM, such as Flash memory.

The mass storage device(s) 28 include various computer readable media, such as magnetic tapes, magnetic disks, optical disks, solid-state memory (e.g., Flash memory), and so forth. As illustrated in FIG. 2, a particular mass storage device is a hard disk drive 40. Various drives may also be included in mass storage device(s) 28 to enable reading from and/or writing to the various computer readable media. The mass storage device(s) 28 include removable media 42 and/or non-removable media.

The I/O device(s) 30 include various devices that allow data and/or other information to be input to or retrieved from the computing device 20. Example I/O device(s) 30 include cursor control devices, keyboards, keypads, microphones, monitors or other display devices, speakers, printers, network interface cards, modems, lenses, CCDs or other image capture devices, and the like.

The display device(s) 32 include any type of device capable of displaying information to one or more users of the computing device 20. Examples of the display device 32 include a monitor, display terminal, video projection device, display, graphical user interface (GUI), and the like.

The interface(s) 26 include various interfaces that allow the computing device 20 to interact with other systems, devices, or computing environments. The interface(s) 26 may include one or more user interface 44 such as GUIs. The interface(s) 26 may include one or more network interfaces 46. Example interface(s) 26 may include any number of different network interfaces 46, such as interfaces to local area networks (LANs), wide area networks (WANs), wireless networks, and the Internet. The interface(s) 26 may also include one or more peripheral device interfaces 48 such as interfaces for printers, pointing devices (mice, track pad, etc.), keyboards, and the like.

The bus(es) 34 allow the processor(s) 22, memory device(s) 24, interface(s) 26, mass storage device(s) 28, I/O device(s) 30, and display(s) 32 to communicate with one another, as well as other devices or components coupled to the bus 34. The bus 34 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of the computing device 20, and are executed by the processor(s) 22. In some embodiments, the systems and procedures described herein can be implemented in hardware, or a combination of hardware, software, and/or firmware. For example, one or more application specific integrated circuits (ASICs) can be programmed to carry out one or more of the systems and procedures described herein.

For clarity in discussing the various functions of the system 10, multiple computers and/or servers are discussed as performing different functions. These different computers (or servers) may, however, be implemented in multiple different ways such as modules within a single computer, as nodes of a computer system, etc. . . . The functions as performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

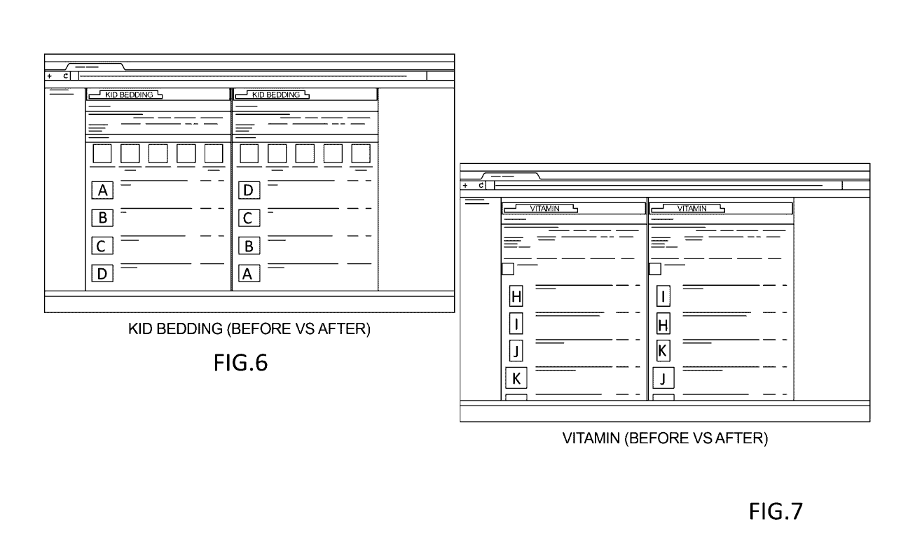

The server 12 is configured to host a website that is accessible by a user via one or more user computing devices 20 or user devices 14. The server 12 retrieves and stores web pages (shown in FIGS. 6 and 7) associated with the website in response to requests received by the user via the user computing device 20 or user device 14 to allow users to interact with the website and search and/or purchase products such as, for example, goods and/or services via the website. In one embodiment, the server is configured to generate and display web pages associated with the website in response to requests being received from consumers via corresponding web browsers that are displayed on the user devices 14. For example, in one embodiment, the server 12 may display a product search webpage (shown in FIGS. 6 and 7) in response to receiving a user request that allows a user to input a product search request including search criteria including one or more search terms. In addition, the server 12 may transmit the product search request to a search engine server and/or a sorting server for use in generating search data in response to the user's search request. The server 12 may also receive one or more product lists from the search engine server and/or the sorting server that includes information associated with products that are selected based on the user's search criteria. The server 12 may also display a search results webpage (shown in FIGS. 6 and 7) to display the product lists to the user and to allow the user to select one or more of the displayed products for purchase.

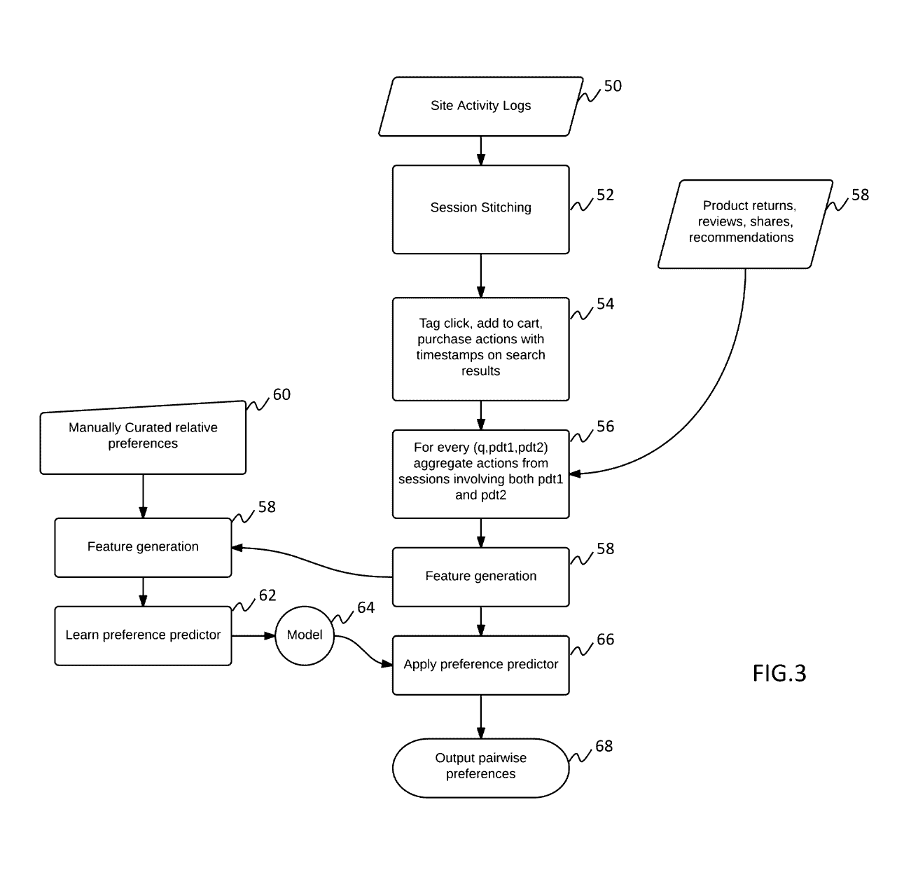

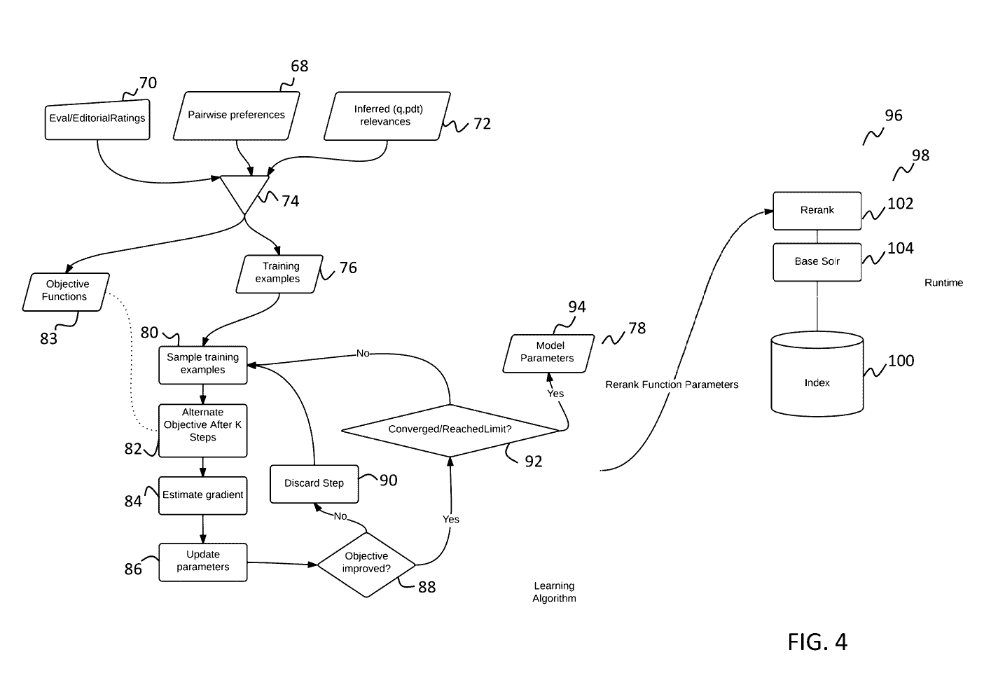

Referring to FIGS. 3 and 4, one embodiment of the system 10 is shown for enhancing online product searches through optimization of product search ranking functions in e-commerce. In one embodiment, the system 10 includes a process for labeled data generation. The system 10 includes a database 50 having one or more logs of website activity from the user devices 14 of users. The website activity logs may be from Hubble, Likeshare, Bazaarvoice, Omniture, etc. For example, the website activity logs record search queries, products viewed, etc. The system 10 also includes a subsystem/module 52 for session stitching. For example, the session stitching module 52 collects all actions of a user for a time period in a website session and in the order that the actions occur. The system 10 includes a subsystem/module 54 of user actions such as tag click, add to cart, and purchase actions with timestamps based on product search results. For example, the module 54 collects what actions the user performs for the products displayed in the search results and what actions the user took such as adding the product to their electronic shopping cart. The system 10 also includes a subsystem/module 56, for every user website session (search query (q), product 1 (pdt1), product 2 (pdt2)), aggregates user actions from website sessions involving search query (q) and both pdt1 and pdt2. The system 10 includes a subsystem/module 58 of product returns, product reviews, product registries, product wish lists, product shares, and product recommendations from users. It should be appreciated that the module 58 receives input from the module 56. It should also be appreciated that the process for labeled data generation flows from database 50 and modules 52, 54, 56 to module 58.

The system 10 also includes a manual data source 60 of product feature generation. For example, the product feature generation is a manual input of information on how long after the user clicks on the product based on the product ranking. The product feature generation may be performed off-line. For example, the system 10 may include a manual data source 60 of manually curated relative preferences. These preferences are manual inputs of a few hundred clicks that provide confidence of product preferences of users. The manual data source 60 is an input into the module 58 for feature generation. The system 10 also includes a subsystem/module 62 for learning to predict preferences. The learn preference predictor is a way to look at user actions that prefer pdt1 over pdt2. The system 10 includes a connector 64 such as a classification model that sees if there is any difference in products based on user actions. It should be appreciated that the off-line process flows from manual data source 60, module 58, and module 62 and connector 64 to module 66 to be described.

The system 10 also includes a subsystem/module 66 of a product preference predictor. The preference predictor is applied by taking all of the product features and determining what is preferred for pdt1 over pdt2. The system 10 includes an output or database 68 of product pairwise preferences. The product pairwise preferences are an output that is collected over a time period, for example six months, of what product preferences are preferred for pdt1 over pdt2. It should be appreciated that the process may flow directly from module 58 to module 66 and that the process flows from module 66 to database 68. It should also be appreciated that the output of product pairwise preferences is used in a learning framework to be described.

Referring to FIG. 4, the system 10 includes a product ranking learning framework. The system 10 includes a manual/crowd generated data source 70 of evaluation/editorial ratings of products. These editorial ratings are based on manual human input. The system 10 also includes a database 72 of inferred (q, pdt) consumer relevances based on search queries and products presented in the search results. The system 10 includes a merge 74 that combines the product pairwise preferences, evaluation/editorial ratings, and inferred consumer relevances into an ideal ranking for products. The output from the merge 74 is an input into a training examples database 76. The training examples are different approaches for product ranking learning. It should be appreciated that the training examples are an input into a learning module 78 to be described that outputs rerank function parameters for products.

The system 10 further includes a learning subsystem/module 78. The learning module 78 integrates inferred product rankings with human editorial ratings for automated tuning of ranking functions for products. The learning module 78 includes a subsystem/module 80 to sample training examples from the database 76. The learning module 78 also includes a subsystem/module 82 that alternates objective/target learning after a predetermined number (K) of steps of tuning ranking. That is, the learning process focuses on editorial quality improvement for a few steps and then switches over to revenue optimization and back and so on. In this module 82, the ranking goes through an iterative process based on the K steps to improve along different dimensions. Sampling helps reduce bias in the ranking. The output from the merge 74 may also go to an objective rerank functions database 83 that may be an input to the module 82. The objective rerank functions database 83 is similar to a product ranking function and is based on editorial ratings for a quoting function. The learning module 78 includes a subsystem/module 84 to estimate a gradient. The gradient is a measure of objective function change of one variable to see if it gets a better ranking or not. The learning module 78 includes a subsystem/module 86 to update rerank function parameters. These are rerank function parameters that act as weights in the ranking function for products. The learning module 78 also includes a decision 88 to determine whether the objective rerank function improved. The learning module 78 includes a subsystem/module 90 for a discard step if the objective rerank function is not improved. The learning module 78 includes a decision 92 to determine whether the objective rerank function converged or reached a limit. The convergence is the number of times that the objective rerank function is upgraded to have provable convergence properties (at least within convex optimization based model refinements). After the discard step in module 90 or if the convergence limit is not reached in decision 92, the learning process returns to the next iteration of sampling training examples in module 80. The leaning module 78 includes a database 94 for model parameters if the convergence limit is reached in decision 92. These model parameters are rerank function parameters for a search engine module 96 to be described. It should be appreciated that the output from the learning module 78 is provided to a ranking module 102 as rerank function parameters or weights to be used in the scoring of products.

The system 10 also includes a search engine server or module 96 to perform a product search. In the illustrated embodiment, the search engine module 96 is configured to receive a product search request from the server 12 including one or more search terms, and generate search data including a plurality of product records as a function of the search terms. For example, in one embodiment, the search engine module 96 may initiate a search algorithm based on a Boolean model to search product records contained in the database based on search terms received from the user. The search engine module 96 generates a search data set including product records matching the search criteria, and generates a relevance score associated with each product record included in the search data set. In one embodiment, the relevance score may be determined based on statistical information, including, but not limited to the number of product records in the database, the frequency with which the search terms appear in the database, and the frequency with which the search term appears in the product record. The relevance of a returned search record may be determined based on the corresponding relevance score and the (relevance) scores of the other product records in the search data set, wherein product records having a higher (relevance) score are more relevant to the search criteria. For example, in one embodiment, the product records may include a product description including one or more terms associated with the corresponding product. The search engine module 96 may generate a relevance score associated with the product record as a function of the number of terms included in the product description that match the search terms included with the product search request. In addition, the relevance score may be within a range between about 0 to 1.0, with a relevance score of 1.0 being indicative of the most relevant product record. It should be appreciated that there are different ways to compute score/different features to use in ranking. It should also be appreciated that bringing them together in a manner best explaining editorial quality and maximizing revenue is the value of the present invention.

In the illustrated embodiment, the search engine module 96 generates the search data in response to the user's product search request and transmits the search data to the sorting server for use in generating products lists being displayed to the user via one or more search results webpage. In one embodiment, the search engine module 96 generates the search data including a plurality of product records. For example, each product record may include a product category value associated with the product category, a price value associated with the price data category, and/or a search relevance score value associated with the relevance score data category.

After the product rerank function parameters are determined, the learning module 78 provides an output of the product rerank function parameters previously described to the search engine module 96. The search engine module 96 includes a search runtime module 98 and a product index database 100 to be described. The runtime module 98 includes a product rerank module 102 and a product base search module 104 to be described. It should be appreciated that the search engine module 96 performs product searches based on a search query form the user device 14 of the user. It should be appreciated that a product catalog database (not shown) is an input to the product index database 100.

The product index database 100 provides input to the product base search module 104 and computes additional signals of the rerank module 102. For example, the product features are computed to pull up products having a higher ranking. It should be appreciated that it is known in the art that computed signals are used for ranking. It should also be appreciated that the rerank module 102 taken as a whole takes a number of products, reorders the order of the products, and returns the ordered list. It should be appreciated that a method and system for re-ranking search results in a product search engine is disclosed in U.S. Patent Application Publication No. 2014/0297630 to Cao et al., the entire disclosure of which is hereby expressly incorporated by reference.

For example, in one embodiment, the sorting server may generate a ranked list of product values based on a number of times each search query term appears in the product data, and select the sorting value as a function of the ranked list of product values. The sorting server generates a ranked list of product values and determines the product values having the highest frequency of appearance in the search data. The sorting server may select a first sorting value indicative of the product value having the highest appearance frequency, and generate the sorted group including product records having corresponding product values matching the sorting value.

In addition, the sorting server may also select a set of sorting values based on the ranked list of product values, and generate the sorted group including product records having corresponding product values matching at least one sorting value included in the set of sorting values. For example, the sorting server may select one or more product values having high appearance frequencies and generate the sorted group including product records having corresponding product values matching the selected product values. The sorting server may also select the group of sorting values including a predefined number of product values.

In one embodiment, the sorting server may select the sorting value including one or more search relevance score values associated with the relevance score data and generate the sorted group as a function of the selected relevance score values. In one embodiment, the sorting server may generate the sorted group including product records having relevance values that are equal to or greater than the sorting value. In another embodiment, the sorting server may select the sorting value including a range of relevance values and generate the sorted group including product records having corresponding relevance values that are within the selected range of relevance values.

For example, in one embodiment, the product records may include search relevance score values within a range between 0 and 1.0. The sorting server may select the sorting value including a search relevance score value such as, for example, a 0.6 relevance score. The sorting server may then generate the sorting group including the product records having a corresponding search relevance score values that is greater than or equal to the sorting value of 0.6 relevance score.

Referring to FIG. 4, the base search module 104 receives a rerank of the product from the rerank module 102. The base search module 104 determines the rank of the products trading off relevance. For example, the base search module 104 determines that the product has a ranking compared to other products. The base search module 104 also includes a product fit module (not shown) that receives a rank of the product. The product fit module determines if the product fits the search query based on a description of the search query and product. For example, the product fit module determines a product intent match based on the products and search query of users, determines text match based on the text of the products and text of the search query of the users, and determines the product fit based on other factors that tie the product to the search query based on presence of search terms in a title of the product. It should be appreciated that the product fit module provides output to an index look-up (not shown) that cooperates with the product index database 100.

The base search module 104 receives the rank of the product and determines the popularity of the product. For example, the popularity of the product may be how many times the product has been viewed or purchased. The base search module 104 also determines the product performance and the product demand. For example, product performance may be how much of the product has been ordered and product demand may be how much the product has been shown to the user. The base search module 104 receives the rank of the product and provides output of the product rank to an index look-up (not shown). It should be appreciated that the product index database 100 is a database of product records or documents stored and accessed by the index look-up. It should also be appreciated that the index look-up and product index database 100 are known in the art. It should be appreciated that the search engine module 96 generates a product list (shown in FIGS. 6 and 7) from the product records and transmits the product list to the server 12 for use in displaying the product list to the user device 14 of the user.

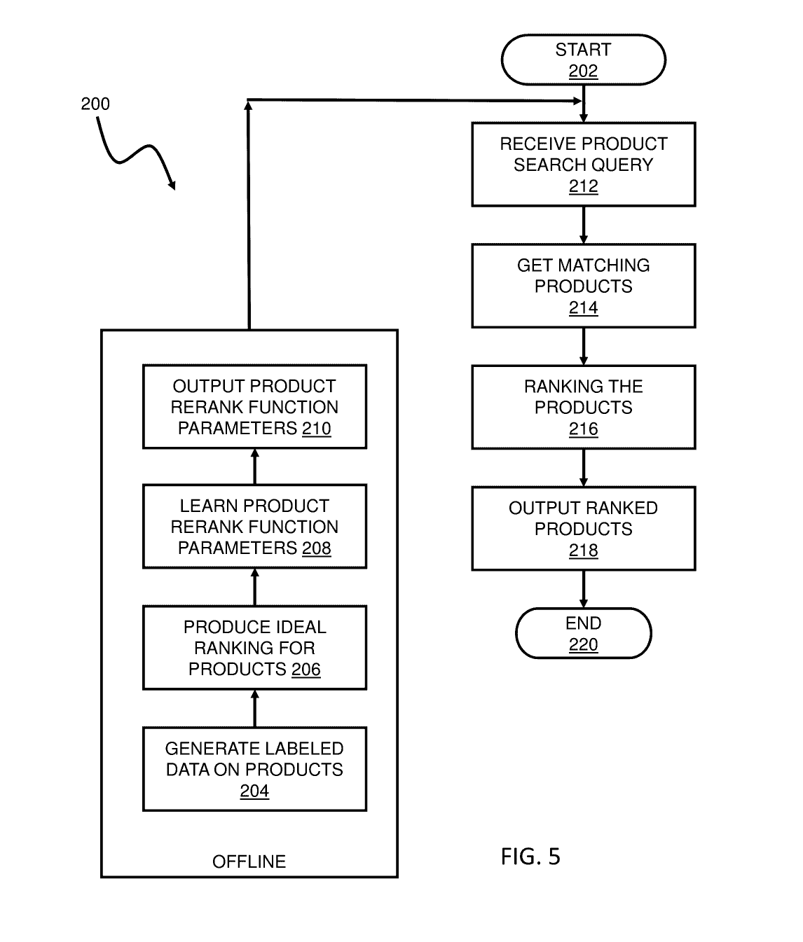

Referring to FIG. 5, a flowchart of a method 200, according to one embodiment of the present invention, used with the system 10 of FIGS. 1 through 4 is shown. The method 200 may be embodied in a products module or server 12 for the system 10. The method 200 starts in block 202. In an offline process, the method 200 includes the step of generating labeled product data on products in block 204. For example, generating, with the server 12, labeled product data on the products to produce pairwise preferences as previously described. The method 200 further includes the step of producing an ideal ranking for products in block 206. For example, combining, with the server 12, the pairwise preferences, editorial ratings of the products, and inferred relevances of the products to produce an ideal ranking for the products as previously described. The method 200 further includes the step of learning product rerank function parameters in block 208. For example, learning, with the server 12, rerank function parameters based on the ideal ranking for the products as previously described. The method 200 also includes the step of outputting product rerank function parameters in block 210. For example, outputting, with the server 12, product rerank function parameters based on the learned rerank function parameters as previously described. It should be appreciated that the product rerank function parameters are learnt and updated monthly in an offline process and there is a single selection of product rerank function parameters for all search queries.

The method 200 includes the steps of receiving a product search query for a product in block 212. For example, receiving a product search query for a product from the user device 14 of the user such as a consumer by the server 12 including the search engine module 96 having a search application as previously described. The method 200 also includes the step of getting matching products in block 214. For example, getting, by the server 12, products that match the product of the search query from the product index database 100 as previously described. The method 200 includes the step of ranking the products in block 216. For example, ranking, with the server 12, the products based on the product rerank function parameters as previously described. It should be appreciated that the products are promoted based on a reranking of relevant products to the product searched.

After block 216, the method 200 further includes outputting reranked products as search results to a user device 14 of a user in block 218. For example, outputting, with the server 12, the ranked products as search results to the user device 14 of the user or consumer for display as previously described. The method then ends in block 220.

Referring to FIGS. 6 and 7, the user device 14 can display a product list as the search results to the user such as a consumer. On the display for FIG. 6, an example of a product search query and the search results listed below the search query. For example, a consumer may have queried or searched for a product, for example such as “kid bedding” or “car booster seat”. The search results on the left show the ranking of the products A, B, C, and D before the present invention. After using the present invention, the search results on the right show a higher ranking for some of the products such as products D, C, B, and A. It should be appreciated that the higher ranking of relevant products results in more sales for the retailer. On the display for FIG. 7, an example of a search query and the search results listed below the search query. For example, a consumer may have queried or searched for a product, for example such as “vitamins” or “Elsa clothing”. The search results on the left show the ranking of the products H, I, J, and K before the present invention. After using the present invention, the search results on the right show a higher ranking for some of the products such as products I, H, K, and J. It should be appreciated that the example of FIGS. 6 and 7 is provided for example only and not intended to be limiting.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein.

The present invention has been described in an illustrative manner. It is to be understood that the terminology, which has been used, is intended to be in the nature of words of description rather than of limitation.

What is claimed is:

1. A system comprising:
a computer system including a server configured to generate labeled data on products to produce pairwise preferences, to combine the pairwise preferences, editorial ratings of the products, and inferred consumer relevances of the products to produce an ideal ranking for the products, to learn rerank function parameters based on the ideal ranking for the products, to output product rerank function parameters based on the learned rerank function parameters; and
the server being configured to receive a product search query from a user device of a user, to get products that match the product search query, to rank the products based on the product rerank function parameters, and to output the ranked products as search results to the user device of the user.

2. A system as set forth in claim 1, wherein the server is configured to account for user actions along a product purchase cycle including at least one of website activity, clicks on search results, add to cart, additions to registries, additions to wish-lists, purchase actions, product returns, product reviews, product shares, product subscriptions, and product recommendations.

3. A system, as set forth in claim 2, wherein the server is configured to aggregate user actions from website sessions involving search query and two products based on the user actions.

4. A system, as set forth in claim 3, wherein the server is configured to generate product pair features based on the aggregate of user actions.

5. A system, as set forth in claim 4, wherein the server is configured to apply a product preference predictor to one of the two products based on the product feature generation.

6. A system, as set forth in claim 1, wherein the server updates product rerank function parameters.

7. A system, as set forth in claim 6, wherein the server determines whether an updated set of product rerank function parameters improves search quality.

8. A system, as set forth in claim 7, wherein the server determines whether a converged limit is reached for the objective function if the objective function/search quality has improved.

9. A system, as set forth in claim 8, wherein the server outputs model rerank function parameters if the converged limit is reached for the objective rerank function.

10. A system, as set forth in claim 9, including a rerank module to receive an input from a learning module, receive input from a product index and a base search module, receive products sorted by relevance from the base search module, and identify products in results from the base search module and move them to higher positions in a final ranking.

11. A method comprising the steps of:
generating, with a computer system, labeled data on products to produce pairwise preferences;
combining, with the computer system, the pairwise preferences, editorial ratings of the products, and inferred consumer relevances of the products to produce an ideal ranking for the products;
learning, with the computer system, rerank function parameters based on the ideal ranking for the products;
outputting, with the computer system, product rerank function parameters based on the learned rerank function parameters;
receiving, with the computer system, a product search query from a user device of a user;
getting, with the computer system, products that match the product search query;
ranking, with the computer system, the products based on the product rerank function parameters; and
outputting, with the computer system, the ranked products as search results to the user device of the user.

12. A method, as set forth in claim 11, including the step of accounting, with the computer system, for user actions along a product purchase cycle including at least one of website activity, clicks on search results, add to cart, additions to registries, additions to wish-lists, purchase actions, product returns, product reviews, product shares, product subscriptions, and product recommendations.

13. A method, as set forth in claim 12, including the steps of aggregating user actions, with the computer system, from website sessions involving search query and two products based on the user actions.

14. A method, as set forth in claim 13, including the steps of generating product pair features, with the computer system, based on the aggregate of user actions.

15. A method, as set forth in claim 14, including the steps of applying a product preference predictor, with the computer system, to one of the two products based on the product feature generation.

16. A method, as set forth in claim 11, including the steps of updating, with the computer system, product rerank function parameters.

17. A method, as set forth in claim 16, including the steps of determining, with the computer system, whether an updated set of product rerank function parameters improves search quality.

18. A method, as set forth in claim 17, including the steps of determining, with the computer system, whether a converged limit is reached for the objective function if the objective function/search quality has improved.

19. A method, as set forth in claim 18, including the steps of outputting, with the computer system, model rerank function parameters if the converged limit is reached for the objective function.

20. A method, as set forth in claim 19, including the steps of providing a rerank module for the computer system and receiving, with the computer system, an input from a learning module, receiving input from a product index and a base search module, receiving products sorted by relevance from the base search module, and identifying products in results from the base search module and moving them to higher positions in a final ranking.

21. One or more non-transitory computer-readable storage media, having computer-executable instructions embodied thereon, wherein when executed by at least one processor, the computer-executable instructions cause the processor to:
generate labeled data on products to produce pairwise preferences;
combine the pairwise preferences, editorial ratings of the products, and inferred consumer relevances of the products to produce an ideal ranking for the products;
learn rerank function parameters based on the ideal ranking for the products;
output product rerank function parameters based on the learned rerank function parameters;
receive a product search query from a user device of a user;
get products that match the product search query;
rank the products based on the product rerank function parameters; and
output the ranked products as search results to the user device of the user.
